(19) United States
(12) Patent Application Publication
(10) Pub. No.: US 2018/0240177 A1
(43) Pub. Date: Aug. 23, 2018

(54) RECORDING MEDIUM, MATCHING METHOD, AND MATCHING DEVICE

(71) Applicants: FUJITSU LIMITED, Kawasaki-shi (JP); KYUSHU UNIVERSITY, NATIONAL UNIVERSITY CORPORATION, Fukuoka-shi (JP)

(72) Inventors: Hiroaki Iwashita, Tama (JP); Kotaro Ohori, Sumida (JP); Naoyuki Kamiyama, Fukuoka (JP); Akifumi Kira, Fukuoka (JP)

(73) Assignees: FUJITSU LIMITED, Kawasaki-shi (JP); KYUSHU UNIVERSITY, NATIONAL UNIVERSITY CORPORATION, Fukuoka-shi (JP)

(21) Appl. No.: 15/897,430

(22) Filed: Feb. 15, 2018

(30) Foreign Application Priority Data
Feb. 17, 2017 (JP) 2017-028404

(51) Int. Cl. G06Q 30/06; G06F 17/30

(52) U.S. Cl. CPC G06Q 30/0631; G06F 17/30386

(57) ABSTRACT

A non-transitory computer-readable recording medium stores therein a matching program that matches a plurality of applicants with matching priorities and a plurality of targets, the matching program causing a computer to execute a process including: setting matching type for each coupling-request applicant with first matching type or second matching type, the coupling request applicant requesting a specific applicant and the coupling-request applicant be matched with a same target, the first matching type performing matching of the coupling-request applicant collectively with the specific applicant, the second matching type performing matching of the coupling-request applicant separately from the specific applicant; and performing and repeating matching the plurality of applicants and the plurality of targets utilizing the matching priorities of the plurality of applicants and the matching type of the coupling-request applicant, until there are no coupling-request applicants with the first matching type whose matching is not established.

### CROSS-REFERENCE TO RELATED APPLICATION

This application is based upon and claims the benefit of priority of the prior Japanese Patent Application No. 2017-028404, filed on Feb. 17, 2017, the entire contents of which are incorporated herein by reference.

### FIELD

The embodiments discussed herein are related to a matching program, a matching method, and a matching device.

### BACKGROUND

In the related art, there is a system matching guardians who desire childcare in childcare facilities to one or more childcare facilities satisfying requested conditions by using a network. In addition, there is known a serial dictatorship mechanism (hereinafter, referred to as an SD mechanism) in a matching process of allocating many applicants (for example, children of guardians who desire childcare) to application targets (for example, childcare facilities).

In the SD mechanism, applicants are assigned with priorities, and in descending order from the applicants with the highest priority, allocation of applicant targets desired by the applicants among the application targets remaining at that time is performed. This SD mechanism guarantees that reversal of priorities will not occur.
Patent Document 1: Japanese Laid-open Patent Publication No. 2002-259728
Non-Patent Document 1: Svensson, Lars-Gunnar. “Strategy-proof allocation of indivisible goods.” Social Choice and Welfare 16.4 (1999): 557-567.

However, in the related art described above, in a case where an applicant who requests coupling is included among applicants, there is a problem that it is difficult to appropriately perform allocation to the application targets.

For example, in application to a plurality of childcare centers, in some cases, a guardian may request coupling of siblings (brothers, older brother and younger sister, older sister and younger brother, and sisters). With respect to applicants who request coupling of siblings, it is unclear how to deal with a relationship with individual priorities, and there is no mechanism of appropriately matching at once. Therefore, in some cases, one of the following Problems 1 to 3 may occur in matching.

Problem 1: A person of which priority is lower than that of the applicant enters the childcare center which the applicant desires to enter (irrespective of a single child or siblings).

Problem 2: Persons as siblings (or not siblings) of which priorities are lower than that of the applicant enter the childcare center which the applicant desires to enter.

Problem 3: Although siblings' entering the same childcare center with a low preference level are better than siblings' entering separate childcare centers according to individual priorities, the siblings enter separate childcare centers.

FIGS. 9 to 11 are explanatory diagrams describing the first to third cases. In the examples of FIGS. 9 to 11, matching of applicants 202a to application targets 201a is performed based on the same application target information 201 and the same applicant information 202.

In addition, the application target information 201 is information on the application targets 201a in which the number of persons admitted to the application targets 201a (childcare centers in the illustrated example) are set in advance. In the illustrated example, two persons are accepted at each of the childcare centers S1 to S3.

The applicant information 202 is information set in advance for the applicants 202a (children in the illustrated example) for each application by the guardian. More specifically, in the applicant information 202, for each child ID identifying the applying child in the application ID indicating the application, the score for determining the priority and the preference order indicating the ranks of the desired application targets 201a are set. For example, the applicants 202a are assigned with priorities in descending order of scores in the applicant information 202. In addition, in a case where a plurality of child IDs are included in the same application ID, for example, it is assumed that there are children who have sibling relationships and there is a coupling request for the children.

As illustrated in FIG. 9, in the first case C1, while ignoring the sibling relationship (coupling request), based on the application target information 201 and the applicant information 202, allocation of the applicants 202a to application targets 201a is performed by the SD mechanism. More specifically, allocation to the application targets 201a desired by the applicants 202a is performed in order (order of I1, J1, K1, K2, L1, and I2 in the illustrated example) from the applicants 202a with the highest priority (S201 to S206).

In this manner, Problem 3 occurs in the first case C1 where allocation is performed by the SD mechanism while ignoring the coupling request. More specifically, siblings K1 and K2 do not enter the same childcare center which is a childcare center (for example, S2) even with a low preference level, but the siblings enter separate childcare centers.

As illustrated in FIG. 10, in the second case C2, allocation is performed in a collective form according to sibling relationship (coupling request) (S211 to S214). In addition, in the second case C2, in the case of collecting according to sibling relationship, the score of the coupled children is set to be in accordance with the higher score.

As illustrated in FIG. 11, in the third case C3, allocation is performed in a collective form according to sibling relationship (coupling request) (S221 to S224). In the third case C3, in the case of collecting in sibling relationship, the score of the coupled children is set to be in accordance with the lower score.

In this manner, in the second case C2 and the third case C3 in which the allocation is performed in a collective form according to the coupling request, distortion occurs in individual prioritization, so that Problem 1 occurs. More specifically, in the second case C2, the applicants 202a with a priority I2 lower than a priority L1 are allocated to the desired application targets 201a (S1 in the illustrated example), and thus, the reversal of priorities occurs. In addition, in the third case C3, the applicants 202a of K1 and K2 with priorities lower than I1 is allocated to the desired application targets 201a (S1 in the illustrated example), and thus, the reversal of priorities occurs.

In this manner, in the case of performing allocation by the SD mechanism while ignoring the sibling relationship (coupling request), Problem 3 frequently occurs. In addition, in the case of performing allocation in a form of collecting siblings (as coupling request), Problem 1 frequently occurs.

### SUMMARY

According to an aspect of the embodiment, a non-transitory computer-readable recording medium stores therein a matching program that matches a plurality of applicants with matching priorities and a plurality of targets, the matching program causing a computer to execute a process including: setting matching type for each coupling-request applicant with first matching type or second matching type, the coupling request applicant requesting a specific applicant and the coupling-request applicant be matched with a same target, the first matching type performing matching of the coupling-request applicant collectively with the specific applicant, the second matching type performing matching of the coupling-request applicant separately from the specific applicant; and performing and repeating matching the plurality of applicants and the plurality of targets utilizing the matching priorities of the plurality of applicants and the matching type of the coupling-request applicant, until there are no coupling-request applicants with the first matching type whose matching is not established, wherein in the performing and the repeating matching, in a case where matching of specific coupling-request applicant with the first matching type is not established, changing the matching type of the specific coupling-request applicant from the first type to the second type.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration example of a matching device according to an embodiment;

FIG. 2 is an explanatory diagram describing application target information and applicant information;

FIG. 3 is a flowchart illustrating an example of operations of a matching device according to the embodiment;

FIG. 4 is a flowchart illustrating an example of a matching process;

FIG. 5 is an explanatory diagram describing matching of applicants to application targets;

FIG. 6 is an explanatory diagram describing matching of applicants to application targets;

FIG. 7 is a flowchart illustrating Modified Example of operations of the matching device according to the embodiment;

FIG. 8 is an explanatory diagram describing an example of a hardware configuration of a matching device according to an embodiment;

FIG. 9 is an explanatory diagram describing a first case;

FIG. 10 is an explanatory diagram describing a second case; and

FIG. 11 is an explanatory diagram describing a third case.

### DESCRIPTION OF EMBODIMENT

Preferred embodiments will be explained with reference to accompanying drawings. In the embodiment, components having the same function are denoted by the same reference numerals, and redundant description will be omitted. In addition, the matching program, the matching method and the matching device described in the following embodiments are merely examples, and the present invention is not limited to the embodiments. In addition, the following embodiments may be appropriately combined within a range not causing inconsistency.

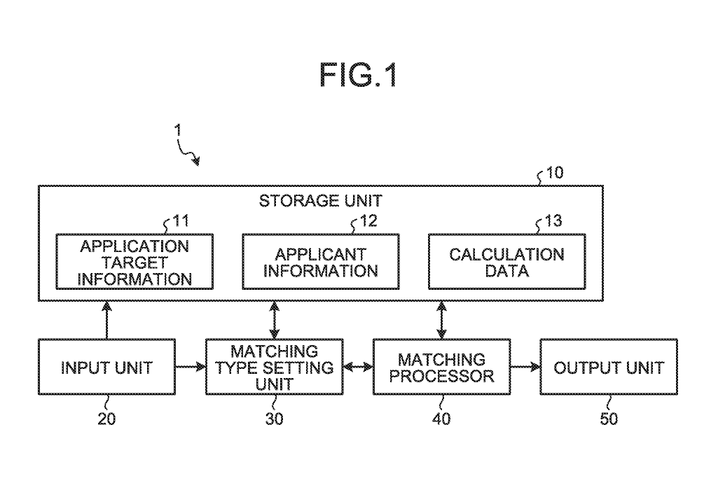

FIG. 1 is a block diagram illustrating a functional configuration example of a matching device according to an embodiment. The matching device 1 illustrated in FIG. 1 is an information process device such as a PC (personal computer). Based on the input information, the matching device 1 performs a matching process between a plurality of applicants assigned with respective priorities and a plurality of application targets and outputs the obtained matching result. Based on the matching result, the user performs allocation of the applicants to the application targets.

In the present embodiment, the application target is defined as a childcare center, and the applicant is defined as a child of a guardian who desires childcare in the childcare center. However, the application targets and the applicants are not limited to the example of the embodiment. For example, the embodiment may be applied to allocation of guests to guest rooms in an inn where applicants are defined as guests and application targets are defined as guest rooms.

As illustrated in FIG. 1, a matching device 1 includes a storage unit 10, an input unit 20, a matching type setting unit 30, a matching processor 40, and an output unit 50.

The storage unit 10 stores input information such as application target information 11 and applicant information 12 input from the input unit 20 and calculation data 13 calculated by the matching processor 40 in a storage device such as a random access memory (RAM), a hard disk drive (HDD), or the like.

The application target information 11 is information on the application targets input by the input unit 20 and set in advance. The applicant information 12 is information on the applicants input by the input unit 20 and set in advance.

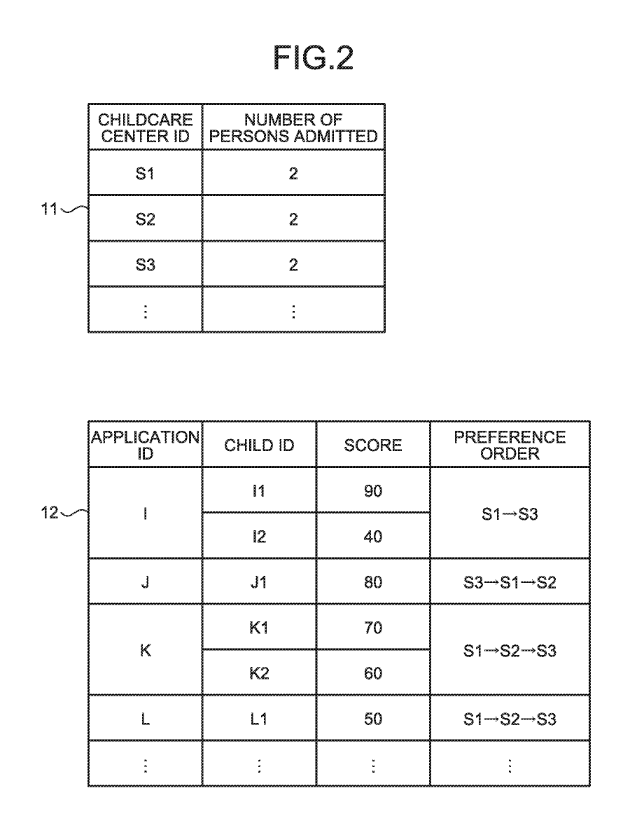

FIG. 2 is an explanatory diagram illustrating the application target information 11 and the applicant information 12. As illustrated in FIG. 2, in the application target information 11, the number of persons admitted to each application target identified by the childcare center ID is set. In the applicant information 12, for each applicant identified by the child ID, the score for determining the priority and the preference order indicating the ranks of the desired application targets 11a are set. The score for each applicant is set to a score calculated by taking into consideration, for example, family circumstances. As a result, each applicant is assigned with a priority in descending order of scores in the applicant information 12.

In addition, in the applicant information 12, in a case where a plurality of child IDs are included in the same application ID, it is assumed that there is a request for coupling children, for example, between the children having sibling relationship (brothers, older brother and younger sister, older sister and younger brother, and sisters). The coupling request is a request for allocating (matching) to application targets in a paired form.

For example, the siblings I1 and I2 and the siblings K1 and K2 are applicants (coupling-request applicants) who have respective sibling relationships with each other and request coupling. The siblings I1 and I2 and the siblings K1 and K2 are persons of which allocation (matching) to the application targets in a paired form is desired by the guardian as an applicant.

Returning to FIG. 1, the input unit 20 receives input information relating to the matching process of the application target information 11, the applicant information 12, and the like from an input device such as a mouse or a keyboard. The input unit 20 stores the received application target information 11 and applicant information 12 in the storage unit 10.

In a case where a plurality of applicants included in the applicant information 12 include coupling-request applicants, the matching type setting unit 30 sets one of the first type (A) or the second type (B) of the coupling correspondence types for each of a plurality of coupling-request applicants associated with the coupling requests. In other words, the matching type setting unit 30 sets one of the first type (A) or the second type (B) of the coupling correspondence types for each of the applicants who desire allocation in a paired form. That is, the matching type setting unit 30 is an example of a setting unit.

The first type (A) is a coupling correspondence type that performs matching of an applicant collectively with different applicants associated with the coupling requests to the application targets. That is, in the first type (A), applicants who desire allocation in a paired form are set to the same priority, and matching is performed in a collective form.

The second type (B) is a coupling correspondence type that performs matching of different applicants associated with the coupling requests to application targets separately. That is, in the second type (B), each applicant who desires allocation in a paired form is assigned with the priority in advance, and allocation is separately performed according to the priority.

More specifically, the matching type setting unit 30 extracts a combination of coupling-request applicants with coupling requests from the applicant information 12. In the example of FIG. 2, a combination of I1 and I2 and a combination of K1 and K2 are extracted. Next, the matching type setting unit 30 sets one of the first type (A) or the second type (B) of the coupling correspondence types to the combination of I1 and I2 and the combination of K1 and K2.

As an example, prior to the matching process by the matching processor 40, the matching type setting unit 30 performs initial type classification of the first type (A) or the second type (B) for the coupling-request applicants with coupling requests. In this initial type classification, for example, the first type (A) is set to all combinations of coupling-request applicants with coupling requests.

The matching processor 40 performs a matching process between a plurality of applicants assigned with respective priorities (scores) and a plurality of application targets. More specifically, by using the SD mechanism, the matching processor 40 performs allocation of the applicants to the application targets that the applicants desire among the application targets remaining at that time in order from the applicant with the highest priority. At this time, for the combination of the coupling-request applicants for which the coupling correspondence type of the first type (A) or the second type (B) is set by the matching type setting unit 30, the matching processor 40 performs allocation according to the set coupling correspondence type.

For example, in the combination of the coupling-request applicants for which the coupling correspondence type of the first type (A) is set, the coupling-request applicants are assigned with the same priority, and the matching is performed in a collective form. In addition, in the combination of the coupling-request applicants for which the coupling correspondence type of the second type (B) is set, the matching of the coupling-request applicants is performed separately according to the priorities assigned in advance.

Then, in a case where matching of each of the coupling-request applicants according to the first type (A) is not established, the matching processor 40 changes the coupling correspondence type of each of the coupling-request applicants of which matching according to the first type (A) is not established from the first type (A) to the second type (B). In addition, a case where the matching of each of the coupling-request applicants according to the first type (A) is not established indicates that matching in a collective form is not achieved due to a condition mismatch such as mismatch of the number of persons admitted in the application target information 11.

After changing the coupling correspondence type of each of the coupling-request applicants of which matching according to the first type (A) is not established from the first type (A) to the second type (B), the matching processor 40 performs the matching process in order from the applicant with the highest priority again. The matching processor 40 repeats the above matching process until there is no coupling-request applicant of which matching of each of the coupling-request applicants according to the first type (A) is not established. Then, the matching processor 40 stores the result of allocation of a plurality of the applicants to a plurality of application targets obtained by the matching process as the calculation data 13 in the storage unit 10.

In this manner, the matching processor 40 obtains a matching (combination) without occurrence of reversal of priorities while leaving the siblings in a collective form (first type (A)) as much as possible. In other words, the matching processor 40 performs matching that suppresses occurrence of Problem 3 as much as possible under conditions that Problems 1 and 2 are not allowed to occur. Therefore, in the matching device 1, it is possible to suppress an event in which the allocation becomes inappropriate in a case where coupling-request applicants are included among the applicants. Therefore, it is possible to minimize dissatisfaction of applicants caused by inappropriate allocation and to minimize the number of coupling-request applicants who are separated from each other.

Based on the calculation data 13 stored in the storage unit 10, the output unit 50 performs displaying on the display device, printing to the printing device, outputting as a file, or the like on the matching result by the matching processor 40, that is, the allocation result of a plurality of applicants to a plurality of application targets.

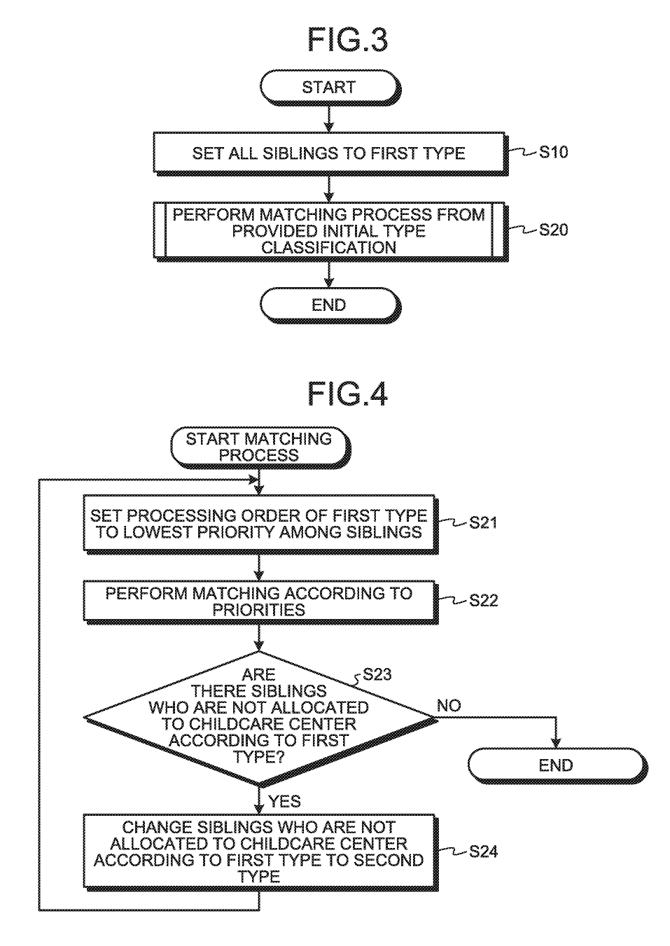

FIG. 3 is a flowchart illustrating an operation example of the matching device 1 according to the embodiment. It is assumed that the application target information 11 and the applicant information 12 are stored in the storage unit 10 in advance. As illustrated in FIG. 3, when the process is started, by referring to the applicant information 12, the matching type setting unit 30 extracts combinations of coupling-request applicants (siblings) with coupling requests and performs an initial type classification of setting all the siblings to the first type (A) (S10).

By setting all the siblings to the first type (A) in the initial type classification as in S10, the matching process is started so that matching of as many siblings as possible can be performed in a collective form.

Next, the matching processor 40 starts the matching process from the initial type classification provided by the matching type setting unit 30 (S20).

FIG. 4 is a flowchart illustrating an example of the matching process. As illustrated in FIG. 4, when the matching process is started, the matching processor 40 sets the processing order of the first type (A) to the lowest priority among the siblings (S21). That is, the matching processor 40 sets the priorities of the combinations of siblings of the first type (A) to be in accordance with the lowest priority set among the siblings. As a result, it is possible to suppress an event in which reversal of priorities frequently occurs.

Next, the matching processor 40 performs matching between a plurality of applicants and a plurality of application targets according to the set priorities while using the coupling correspondence type for the siblings, in order from the applicant with the highest priority (S22).

Next, the matching processor 40 determines whether or not there are siblings who are not allocated to a childcare center according to the first type (A) in matching, that is, whether or not there are siblings of which matching is not established in a collective form (S23). In a case where there are no siblings who are not allocated to a childcare center according to the first type (A) (S23: NO), the matching processor 40 ends the matching process.

In a case where there are siblings who are not allocated to a childcare center according to the first type (A) (S23: YES), the matching processor 40 changes the coupling correspondence type of the siblings which are not allocated to a childcare center according to the first type (A) to the second type (B) (S24). Next, the matching processor 40 returns the process to S21 and repeats the matching process.

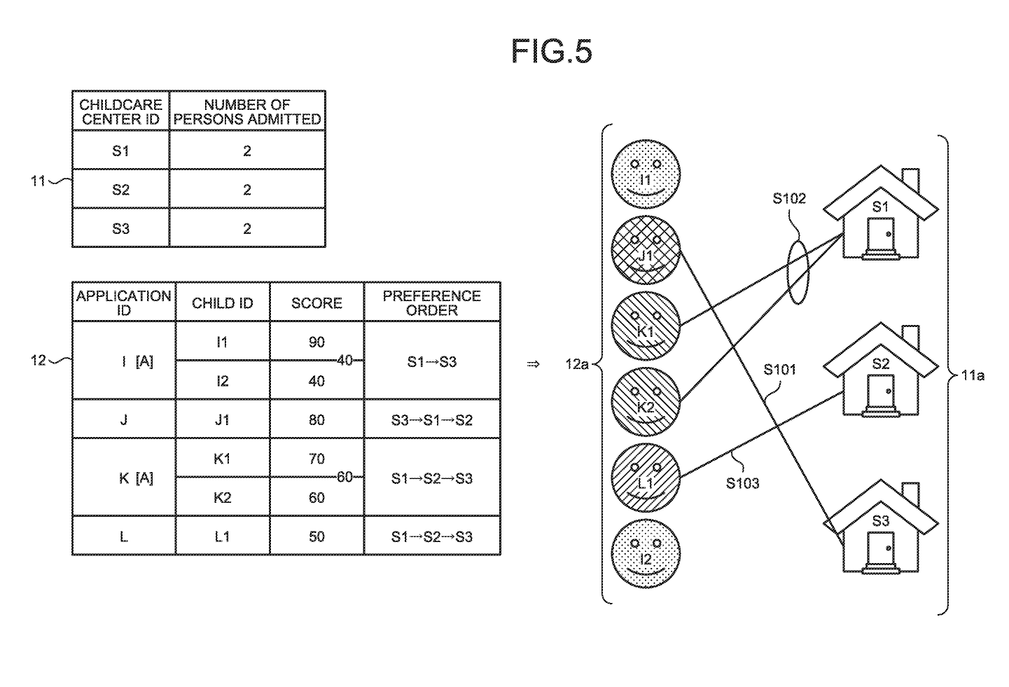

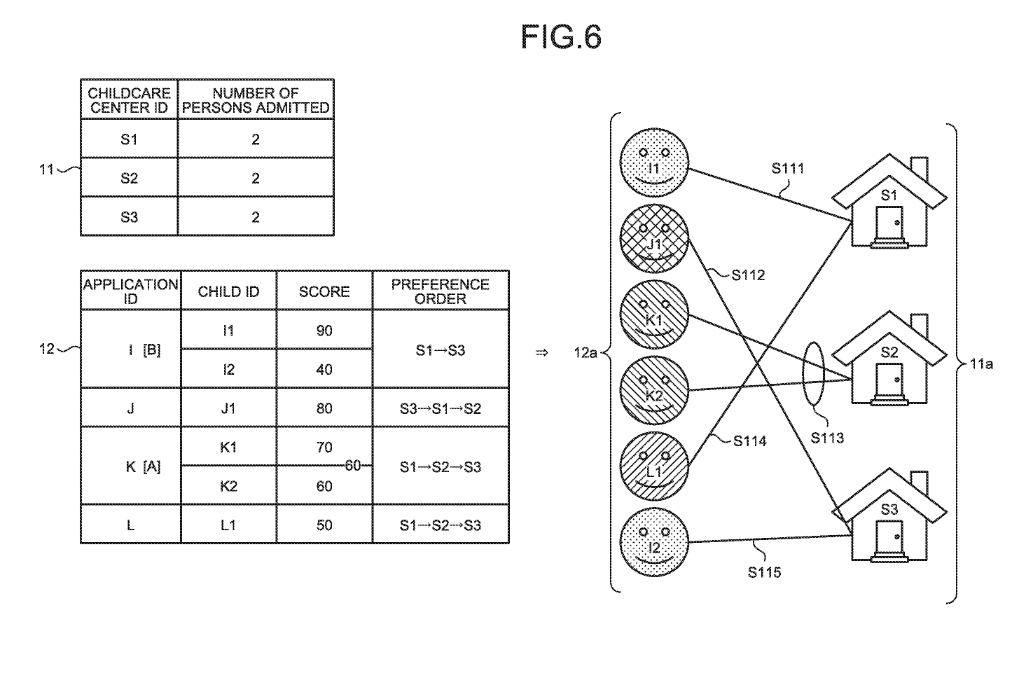

FIGS. 5 and 6 are explanatory diagrams illustrating matching of applicants to application targets. As illustrated in FIG. 5, in the initial type classification (S10), the first type (A) is set for all the combinations of siblings (I1 and I2, K1 and K2). Therefore, for the combinations of siblings according to the first type (A), the lowest priority among the siblings is set. For example, in the combination of I1 having a score of “90” and I2 having a score of “40”, the score is set to “40”.

Next, the matching processor 40 performs first-order matching in which the allocation to the application target 11a is performed in order from the applicant 12a with the highest priority while using the coupling correspondence type for the siblings (S101 to S103). More specifically, allocation to the application target 11a is performed in order from J1 with the highest score so as to satisfy the set preference order. Following S103, when allocation of the combination of siblings I1 and I2 to the application targets 11a is to be performed in a collective form, the numbers of persons admitted to the side of the application targets 11a do not match with each other, and the allocation fails.

In this case, as illustrated in FIG. 6, the matching processor 40 changes the coupling correspondence type of the siblings I1 and I2 who are not allocated to the childcare center according to the first type (A) to the second type (B), and the second-order matching is repeated (S111 to S115). As a result, matching of the siblings I1 and I2 is performed separately according to the priorities set separately. In the second-order matching, there are no siblings of which matching according to the first type (A) is not established.

Therefore, matching according to S111 to S115 is achieved as a result of allocation of a plurality of applicants 12a to a plurality of application targets 11a. In this allocation result, I1 and I2 are not allocated to the same application target 11a (childcare center). However, the applicants (I) of I1 and I2 consider that “all childcare centers are full of the applicants 12a with higher priorities than that of I2, so we have no choice (there is no problem).”

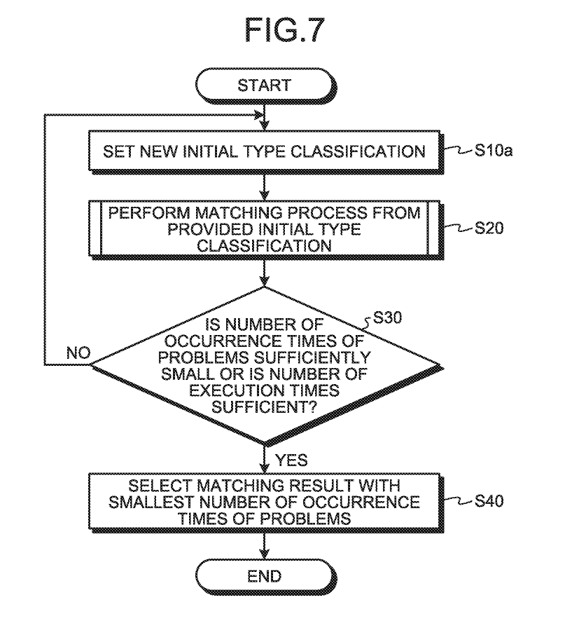

FIG. 7 is a flowchart illustrating a modified example of the operation of the matching device 1 according to the embodiment. As illustrated in FIG. 7, in the modified example, the matching process are performed several times in different settings of an initial classification type (S10a) to select the matching result with low-frequent occurrence of problems (for example, a case where the siblings are separated from each other due to changing to the second type).

More specifically, when the process is started, the matching type setting unit 30 sets a new initial type classification for the combination of coupling-request applicants (siblings) at every process (S10a).

In addition, the initial type classification may be one of the following, for example.

(1) Setting all siblings to the first type (A)

(2) Setting siblings of which priorities (either average of priorities or individual priorities) are higher than a predetermined threshold to the first type (A)

(3) Based on the result of the latest matching process, setting the siblings of the following (3-1) to (3-2) to the first type (A)

(3-1) Siblings who succeeded in being allocated to the same childcare center

(3-2) Siblings who have experienced Problem 3

(4) Based on past matching results stored in the calculation data 13, setting the siblings of the following (4-1) to (4-2) to the first type (A)

(4-1) Siblings who have succeeded in being allocated to the same childcare center (with many times of successes)

(4-2) Siblings who have experienced Problem 3 (with many times of occurrence)

(5) Setting the first type (A) or the second type (B) at random

Next, the matching processor 40 performs the matching process from the initial type classification provided by the matching type setting unit 30 (S20). Next, the matching processor 40 evaluates the number of occurrence times of the problem such as the cases where the siblings are separated by changing to the second type and the number of execution times of the processes of S10a to S20. Next, based on the evaluation result, the matching processor 40 determines whether the number of occurrence times of the problem is equal to or less than a predetermined value and whether or not the process has been performed in the state where the number of occurrence times of the problems is sufficiently small or with the sufficient number of execution times equal to or more than a predetermined number (S30).

In a case where the process has not been performed in the state where the number of occurrence times of the problems is sufficiently small or with the sufficient number of execution times, (S30: NO), the matching processor 40 returns the process to S10a. In a case where the process has been performed in the state where the number of occurrence times of the problems is sufficiently small or with the sufficient number of execution times, (S30: YES), the matching processor 40 selects the matching result with the smallest number of occurrence times of the problems among the matching results obtained for the number of execution times and stored as the calculation data 13 (S40). As a result, the matching device 1 can obtain the matching result in which the number of occurrence times of problems such as siblings being separated among different initial classification types is small.

As described above, the matching device 1 is a device that executes a matching process between a plurality of applicants 12a each of which is assigned with a priority and a plurality of application targets 11a and includes a matching type setting unit 30 and a matching processor 40. The matching type setting unit 30 sets each of the coupling-request applicants who desire matching in a paired form among the plurality of applicants 12a to one of coupling correspondence types of a first type of performing matching collectively and a second type of performing matching separately. The matching processor 40 performs matching between a plurality of applicants 12a and a plurality of application targets 11a by using priorities and a coupling correspondence type. In addition, in a case where matching of each of the coupling-request applicants according to the first type is not established, the matching processor 40 changes the coupling correspondence type of each coupling-request applicant from the first type to the second type. Then, the matching processor 40 repeats matching until there is no coupling-request applicant of which matching of each of the coupling-request applicants according to the first type is not established.

In this manner, in the matching device 1, matching (combination) without occurrence of reversal of priorities is obtained while leaving the siblings in a collective form according to the first type as much as possible. Thereby, in the matching device 1, it is possible to suppress an event in which the allocation becomes inappropriate in a case where the applicants 12a who request coupling are included among the applicants 12a.

Herein, it is assumed that, in the first case C1 (ignoring a sibling relationship), the second case C2 (collecting siblings according to high scores), the third case C3 (collecting siblings according to low scores), and the present embodiment, the experiment results under the following setting conditions in the matching device 1 are listed the table.

Setting Condition
Number of childcare centers: 200
Number of children to be admitted for each childcare center: 20
Number of children: 7,000
Number of siblings: 1,400 pairs
The scores and the preference order are set at random, and experiments are performed with 1,000 different patterns.

TABLE 1

| | Problem 1 | Problem 2 | Problem 3 |
|---|---|---|---|
| Ignoring sibling | 0.0 | 0.0 | 326.3 |
| relationship | | | |
| Collecting siblings | 4516.7 | 518.4 | 344.9 |
| according to high scores | | | |
| Collecting siblings | 579.1 | 0.0 | 0.0 |
| according to low scores | | | |
| Present embodiment | 0.0 | 0.0 | 0.2 |

As listed in the table of experiment results, in the present embodiment, as compared with the first case C1, the second case C2, and the third case C3, it is possible to obtain a matching result of suppressing the occurrence of Problem 3 as much as possible without causing Problems 1 and 2.

In addition, each components of each device illustrated in the drawings is not necessarily physically configured as illustrated in the drawings. That is, a specific form of distribution/integration of devices is not limited to those illustrated in the drawing, and all or a portion thereof may be distributed or integrated functionally or physically in arbitrary units according to various loads, usage conditions, or the like.

The various process functions performed by the matching device 1 may be executed entirely or arbitrarily partially on a CPU (or a micro computer such as an MPU or a micro controller unit (MCU)). In addition, it goes without saying that all or some of the various process functions may be executed on a program analyzed and executed by a CPU (or a micro computer such as an MPU or an MCU) or on hardware by wired logic. In addition, the various process functions performed by the matching device 1 may be executed by a plurality of computers in cooperation by cloud computing.

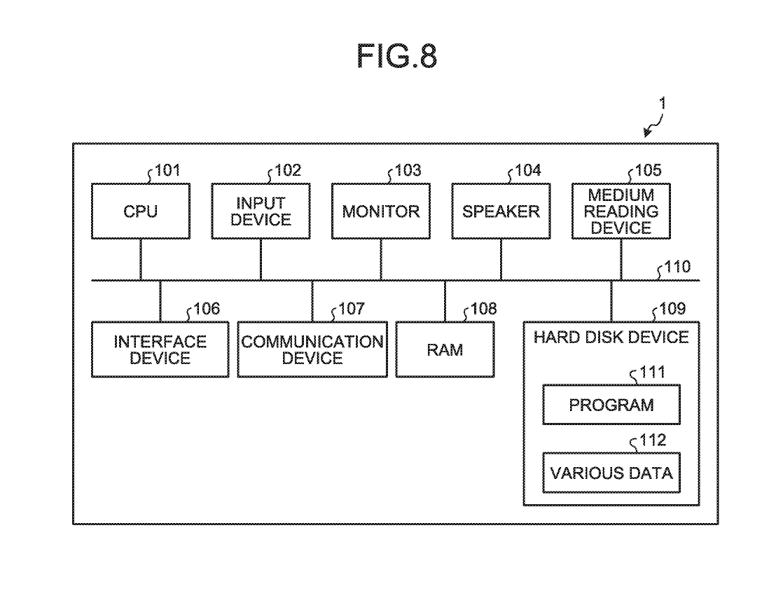

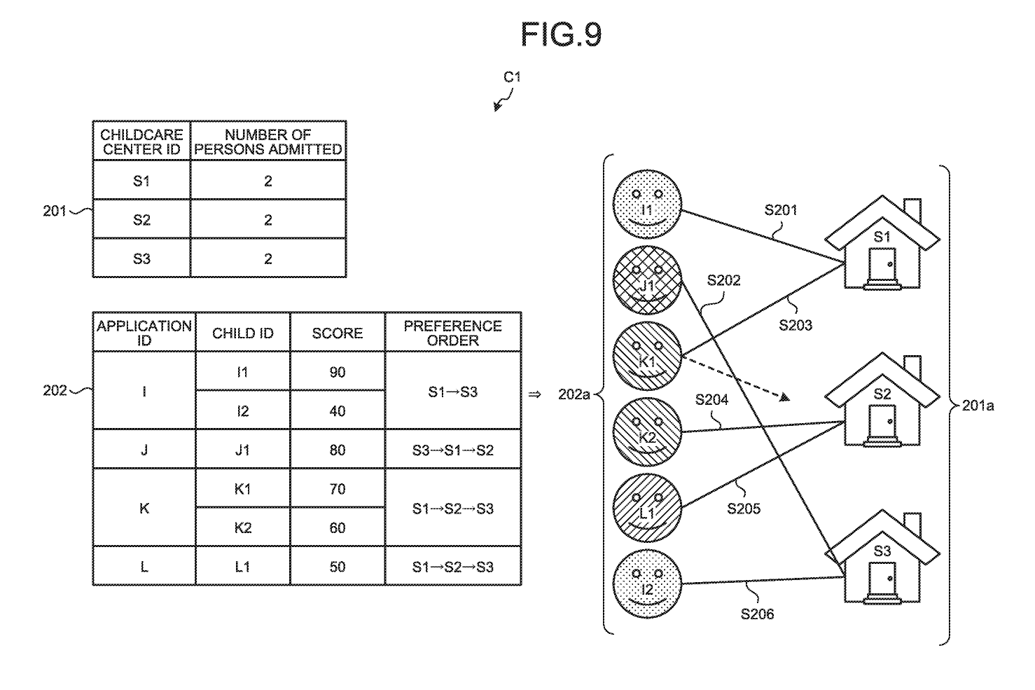

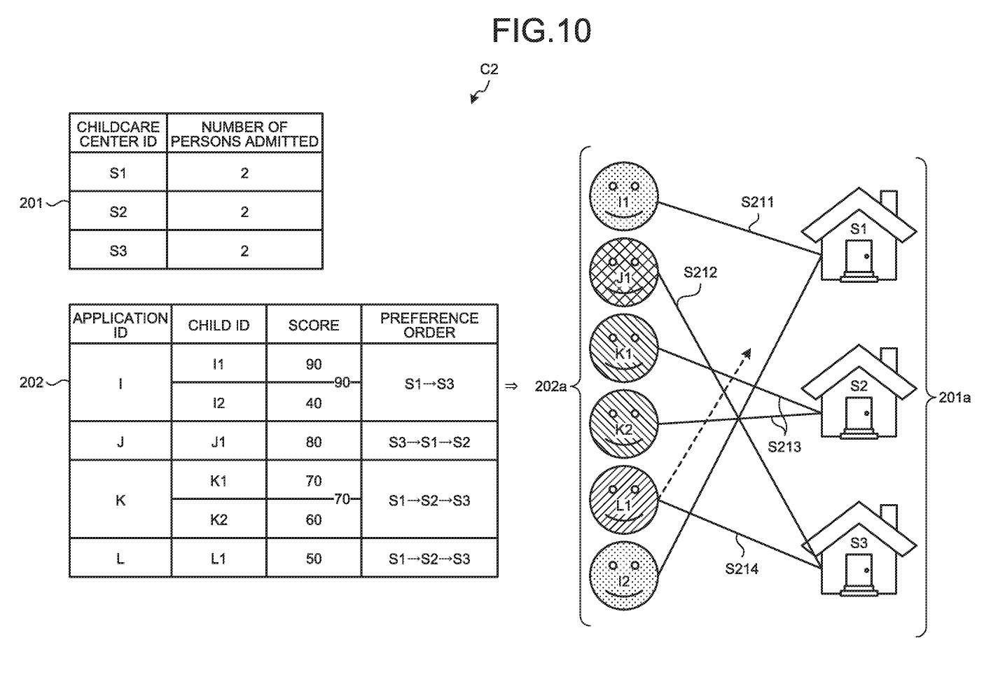

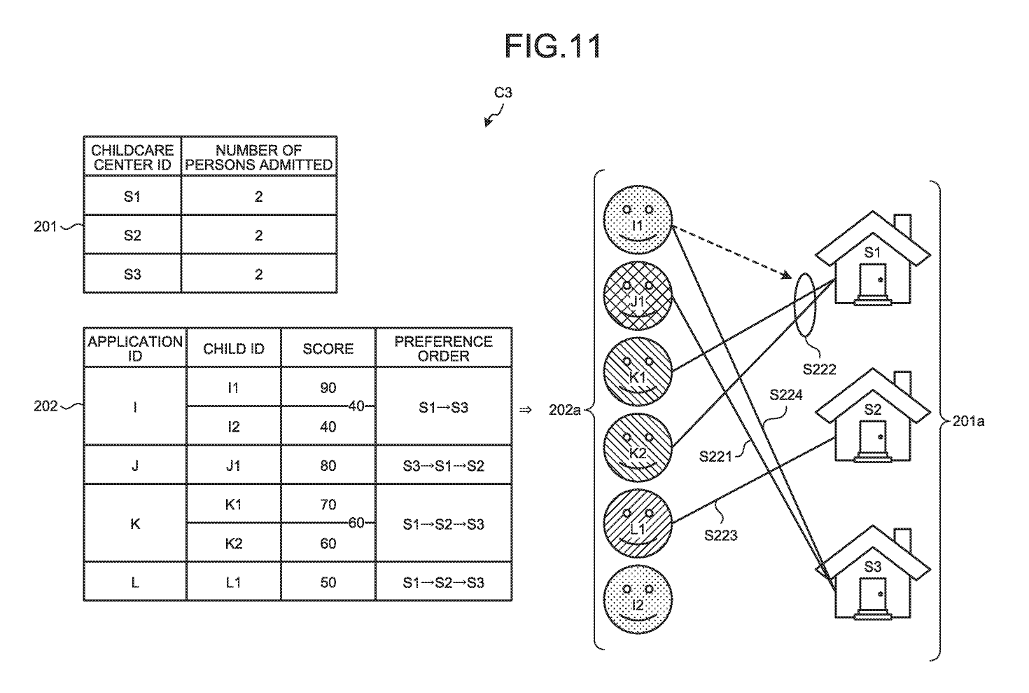

The various processes described in the above embodiment may be realized by causing a computer to execute a program prepared in advance. Therefore, hereinafter, an example of a computer (hardware) that executes a program having the same functions as those in the above embodiment will be described. FIG. 8 is an explanatory diagram illustrating an example of a hardware configuration of the matching device 1 according to the embodiment.

As illustrated in FIG. 8, the matching device 1 includes a CPU 101 that executes various calculation processes, an input device 102 that receives data input, a monitor 103, and a speaker 104. In addition, the matching device 1 includes a medium reading device 105 for reading a program or the like from a storage medium, an interface device 106 for connecting to various devices, and a communication device 107 for communicating with an external device by wired or wireless connection. In addition, the matching device 1 includes a RAM 108 for temporarily storing various types of information, and a hard disk device 109. In addition, each component (101 to 109) in the matching device 1 is connected to a bus 110.

The hard disk device 109 stores a program 111 for executing various processes described in the above embodiment. In addition, various data 112 to be referred to by the program 111 are stored in the hard disk device 109. The input device 102 receives input of operation information from, for example, an operator of the matching device 1. For example, the monitor 103 displays various screens operated by the operator. For example, a printing device or the like is connected to the interface device 106. The communication device 107 is connected to a communication network such as a local area network (LAN) and exchanges various types of information with an external device via a communication network.

The CPU 101 reads the program 111 stored in the hard disk device 109, develops the program 111 in the RAM 108, and executes the program to perform various processes. In addition, it is possible that the program 111 is not stored in the hard disk device 109. For example, the matching device 1 may read and execute the program 111 stored in a storage medium readable by the matching device 1. The storage medium readable by the matching device 1 corresponds to, for example, a portable recording medium such as a CD-ROM, a DVD disk, or a universal serial bus (USB) memory, a semiconductor memory such as a flash memory, a hard disk drive, or the like. Alternatively, this program may be stored in a device connected to a public line, the Internet, a LAN, or the like, and the matching device 1 may read the program from the public line, the Internet, the LAN, or the like and execute the program.

According to an embodiment of the present invention, it is possible to suppress an event in which allocation becomes inappropriate in a case where an applicant who requests coupling is included among applicants.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a matching program that matches a plurality of applicants with matching priorities and a plurality of targets, the matching program causing a computer to execute a process comprising:
setting matching type for each coupling-request applicant with first matching type or second matching type, the coupling request applicant requesting a specific applicant and the coupling-request applicant be matched with a same target, the first matching type performing matching of the coupling-request applicant collectively with the specific applicant, the second matching type performing matching of the coupling-request applicant separately from the specific applicant; and
performing and repeating matching the plurality of applicants and the plurality of targets utilizing the matching priorities of the plurality of applicants and the matching type of the coupling-request applicant, until there are no coupling-request applicants with the first matching type whose matching is not established, wherein
in the performing and the repeating matching, in a case where matching of specific coupling-request applicant with the first matching type is not established, changing the matching type of the specific coupling-request applicant from the first type to the second type.

2. The non-transitory computer-readable recording medium according to claim 1, wherein the plurality of coupling-request applicants associated with the coupling request are applicants who have sibling relationships with each other.

3. The non-transitory computer-readable recording medium according to claim 1, wherein the matching is matching between a plurality of children assigned with priorities and a plurality of childcare centers.

4. The non-transitory computer-readable recording medium according to claim 1, wherein
the setting includes setting all of the plurality of coupling-request applicants associated with the coupling request to the first type, and
the repeating includes repeating matching from a state where all is set to the first type until there is no coupling-request applicant of which matching of each of the coupling-request applicants according to the first type is not established.

5. The non-transitory computer-readable recording medium according to claim 1, wherein the repeating includes performing matching using the coupling correspondence type by setting the priorities of the coupling-request applicants according to the first type to be in accordance with a lower priority.

6. A matching method comprising:
setting matching type for each coupling-request applicant with first matching type or second matching type, the coupling request applicant requesting a specific applicant and the coupling-request applicant be matched with a same target, the first matching type performing matching of the coupling-request applicant collectively with the specific applicant, the second matching type performing matching of the coupling-request applicant separately from the specific applicant, by a processor; and
performing and repeating matching the plurality of applicants and the plurality of targets utilizing the matching priorities of the plurality of applicants and the matching type of the coupling-request applicant, until there are no coupling-request applicants with the first matching type whose matching is not established, wherein
in the performing and the repeating matching, in a case where matching of specific coupling-request applicant with the first matching type is not established, changing the matching type of the specific coupling-request applicant from the first type to the second type, by the processor.

7. The matching method according to claim 6, wherein the plurality of coupling-request applicants associated with the coupling request are applicants who have sibling relationships with each other.

8. The matching method according to claim 6, wherein the matching is matching between a plurality of children assigned with priorities and a plurality of childcare centers.

9. The matching method according to claim 6, wherein
the setting includes setting all of the plurality of coupling-request applicants associated with the coupling request to the first type, by the processor, and
the repeating includes repeating matching from a state where all is set to the first type until there is no coupling-request applicant of which matching of each of the coupling-request applicants according to the first type is not established, by the processor.

10. The matching method according to claim 6, wherein the repeating includes performing matching using the coupling correspondence type by setting the priorities of the coupling-request applicants according to the first type to be in accordance with a lower priority, by the processor.

11. A matching device comprising:
a processor configured to:
set matching type for each coupling-request applicant with first matching type or second matching type, the coupling request applicant requesting a specific applicant and the coupling-request applicant be matched with a same target, the first matching type performing matching of the coupling-request applicant collectively with the specific applicant, the second matching type performing matching of the coupling-request applicant separately from the specific applicant; and
perform and repeat matching the plurality of applicants and the plurality of targets utilizing the matching priorities of the plurality of applicants and the matching type of the coupling-request applicant, until there are no coupling-request applicants with the first matching type whose matching is not established, wherein
in the performing and the repeating matching, in a case where matching of specific coupling-request applicant with the first matching type is not established, changing the matching type of the specific coupling-request applicant from the first type to the second type.

12. The matching device according to claim 11, wherein the plurality of coupling-request applicants associated with the coupling request are applicants who have sibling relationships with each other.

13. The matching device according to claim 11, wherein the matching is matching between a plurality of children assigned with priorities and a plurality of childcare centers.

14. The matching device according to claim 11, wherein the processor is further configured to:
set all of the plurality of coupling-request applicants associated with the coupling request to the first type, and
repeat matching from a state where all is set to the first type until there is no coupling-request applicant of which matching of each of the coupling-request applicants according to the first type is not established.

15. The matching device according to claim 11, wherein the processor is further configured to perform matching using the coupling correspondence type by setting the priorities of the coupling-request applicants according to the first type to be in accordance with a lower priority.
